(19) United States
(12) Patent Application Publication
(10) Pub. No.: US 2012/0199101 A1
(43) Pub. Date: Aug. 9, 2012

(54) PRESSURE RECOVERY SYSTEM FOR LOW LEAKAGE CAM ASSISTED COMMON RAIL FUEL SYSTEM, FUEL INJECTOR AND OPERATING METHOD THEREFOR

(75) Inventors: Dana R. Coldren, Secor, IL (US); Alan R. Stockner, Metamora, IL (US)

(73) Assignee: Caterpillar Inc., Peoria, IL (US)

(21) Appl. No.: 13/022,042

(22) Filed: Feb. 7, 2011

(51) Int. Cl. F02M 69/46; F02M 51/00

(52) U.S. Cl. 123/456; 123/472; 123/478

(57) ABSTRACT

A fuel system includes a plurality of fuel injectors each defining a nozzle supply passage, a nozzle outlet, a low pressure space, and a drain. The fuel system includes a plurality of mechanically actuated pressure intensifiers each including a tappet and being positioned partially within one of the fuel injectors, and a common rail fluidly connecting with each of the fuel injectors. Each of the fuel injectors further includes an injection pressure control mechanism having an injection pressure control valve. Each injection pressure control valve blocks the corresponding pressure intensifier from the common rail and fluidly connects the pressure intensifier with the low pressure space at a first position, and fluidly connects the pressure intensifier with the common rail and blocks the pressure intensifier from the low pressure space at a second position. Each of the fuel injectors further includes a pressure recovery mechanism having a pressure recovery valve. Each pressure recovery valve blocks the corresponding pressure intensifier from the common rail and fluidly connects the low pressure space and the drain at the first position, and fluidly connects the low pressure space with the common rail and blocks the low pressure space from the drain at the second position. Injecting fuel via operating the fuel system may include operating the fuel system in a low leakage mode where the pressure intensifier displaces fuel at a low pressure, between high pressure injections.

### TECHNICAL FIELD

The present disclosure relates generally to fuel systems and fuel system operating methods, for internal combustion engines, and relates more particularly to a pressure recovery method for use when operating a common rail fuel system having a cam actuated pressure intensifier in a low leakage mode.

### BACKGROUND

Many types of fuel injection systems for internal combustion engines have been developed over the years. Common rail fuel injection systems are well known and widely used in connection with multi-cylinder internal combustion engines. A typical common rail fuel system includes a low-pressure fuel source, a high-pressure pump and a common rail connecting the high pressure pump with a plurality of fuel injectors. Injection of fuel at rail pressure can occur relatively precisely by electronically controlling each of the fuel injectors coupled with the common rail. Common rail systems have seen widespread success in part because they provide a relatively simple and straightforward means for providing fuel to a plurality of fuel injectors, and enable injection of fuel at relatively precise times and injection amounts. Common rail systems have also proven to be a relatively efficient and effective way to handle relatively high fuel pressures. While known common rail systems have long served as an industry standard for high pressure fuel injection practices, there is room for improvement.

On the one hand, containing a volume of highly pressurized fuel can be relatively difficult, requiring specialized hardware such as seals and plumbing. Parts subjected to extremely high pressures may also have a tendency to wear relatively more quickly than parts used in lower pressure environments. It can also require significant engine output energy to maintain a relatively large volume of fuel at high pressure. Relying solely upon a common rail as a pressure source for fuel can ultimately impact engine efficiency.

Systems have been proposed where a common rail is used to supply fuel at a first pressure to a plurality of fuel injectors of an engine system. A hydraulically actuated or cam actuated pressure intensifier may also be used in such systems to enable fuel injection at selective times at a higher pressure. United States Patent Application Publication No. 2006/0243253 to Knight proposes incorporating a cam actuated piston to a common rail system to enable injection of fuel at rail pressure from the common rail, or at a higher pressure from the pressure intensifier. In Knight's system, the cam actuated pressure intensifier is also used to assist in maintaining the pressure of the common rail when it is not being used to directly elevate fuel pressure for an injection. As a result, the piston in Knight will apparently pump at high pressure continuously. Continuously subjecting components of the fuel system to high pressure from the piston in Knight may result in excessive leakage between and among certain components. Leakage of high pressure fuel as in Knight would tend to waste energy, as the engine output energy used to pressurize the leaked fuel cannot readily be recovered.

### SUMMARY OF THE INVENTION

In one aspect, a method of operating a fuel system for an internal combustion engine including a step of injecting fuel into an engine cylinder at a medium pressure at least in part by fluidly connecting a nozzle outlet of a fuel injector with a common rail. Also included is a step of increasing a pressure of fuel in a plunger cavity of the fuel injector from a low pressure to the medium pressure by fluidly connecting the plunger cavity with the common rail. The method also includes a step of increasing a pressure of fuel in the plunger cavity from the medium pressure to a high pressure by moving a tappet of a pressure intensifier. Also included is a step of injecting fuel at the high pressure into the engine cylinder at least in part by fluidly connecting the nozzle outlet with the plunger cavity. The method also includes a step of operating the fuel system in a pressure recovery mode subsequent to injecting fuel at the high pressure at least in part via a step of returning a pressure of fuel in the plunger cavity from the high pressure to the medium pressure.

In another aspect, a fuel injector including an injector body defining a nozzle supply passage, a nozzle outlet connecting with the nozzle supply passage, a control passage, a low pressure space, at least one fuel inlet connecting with the nozzle supply passage, a plunger cavity, a pressure intensification passage connecting the plunger cavity with the nozzle supply passage within the injector body, a pressure recovery conduit, and at least one drain. The fuel injector also includes a direct control needle check positioned within the injector body and movable between a closed position blocking the nozzle outlet from the nozzle supply passage and an open position, the direct control needle check having an opening hydraulic surface exposed to a fluid pressure in the nozzle supply passage and a closing hydraulic surface exposed to a fluid pressure in the control passage. Also included in the fuel injector is a check control valve movable between a first injection control position at which the control passage is blocked from the low pressure space and a second injection control position at which the control passage is open to the low pressure space. The fuel injector further includes a pressure intensifier positioned partially within the injector body, the pressure intensifier including a tappet and a plunger configured to move between a first plunger position and an advanced plunger position within the plunger cavity. Also included in the fuel injector is a one-way valve positioned fluidly between the pressure intensification passage and the nozzle supply passage and permitting fluid flow from the plunger cavity to the nozzle supply passage. The fuel injector further includes an injection pressure control mechanism having a first pressure control configuration and a second pressure control configuration, the injection pressure control mechanism blocking the plunger cavity from the at least one fuel inlet and fluidly connecting the plunger cavity with the low pressure space in the first pressure control configuration, and the injection pressure control mechanism fluidly connecting the plunger cavity with the at least one fuel inlet and blocking the plunger cavity from the low pressure space in the second pressure control configuration. The fuel injector also includes a pressure recovery mechanism having a first pressure recovery configuration and a second pressure recovery configuration, the pressure recovery mechanism blocking the low pressure space from the pressure recovery conduit and fluidly connecting the low pressure space with the drain conduit in the first pressure recovery configuration, and the pressure recovery mechanism fluidly connecting the low pressure space with the pressure recovery conduit and blocking the low pressure space from the drain conduit in the second pressure recovery configuration.

In yet another aspect, a fuel system for an internal combustion engine including a plurality of fuel injectors, each of the fuel injectors including an injector body defining a nozzle supply passage, a nozzle outlet connecting with the nozzle supply passage, a low pressure space, and a drain. The fuel system further includes a plurality of mechanically actuated pressure intensifiers each including a tappet and being positioned partially within one of the injector bodies. Also included in the fuel system is a common rail fluidly connecting with each of the fuel injectors. Each of the fuel injectors further include an injection pressure control mechanism which includes an injection pressure control valve movable between a first pressure control position and a second pressure control position, and wherein each of the injection pressure control valves blocks the corresponding pressure intensifier from the common rail and fluidly connects the pressure intensifier with the low pressure space at the first pressure control position, and wherein each of the injection pressure control valves fluidly connects the pressure intensifier with the common rail and blocks the pressure intensifier from the low pressure space at the second pressure control position. Each fuel injector also includes a pressure recovery mechanism, which includes a pressure recovery valve movable between a first pressure recovery position and a second pressure recovery position, and wherein each of the pressure recovery valves blocks the corresponding pressure intensifier from the common rail and fluid connects the pressure intensifier with the drain at the first pressure recovery position, and wherein each of the pressure recovery valves fluidly connects the pressure intensifier with the common rail and blocks the pressure intensifier from the drain at the second pressure recovery position.

### BRIEF DESCRIPTION OF THE DRAWINGS

FIG. 1 is a diagrammatic view of an internal combustion engine, having mechanically intensified fuel injectors, according to one embodiment; and

FIG. 2 is a side diagrammatic view of a mechanically intensified fuel injector, according to one embodiment.

### DETAILED DESCRIPTION

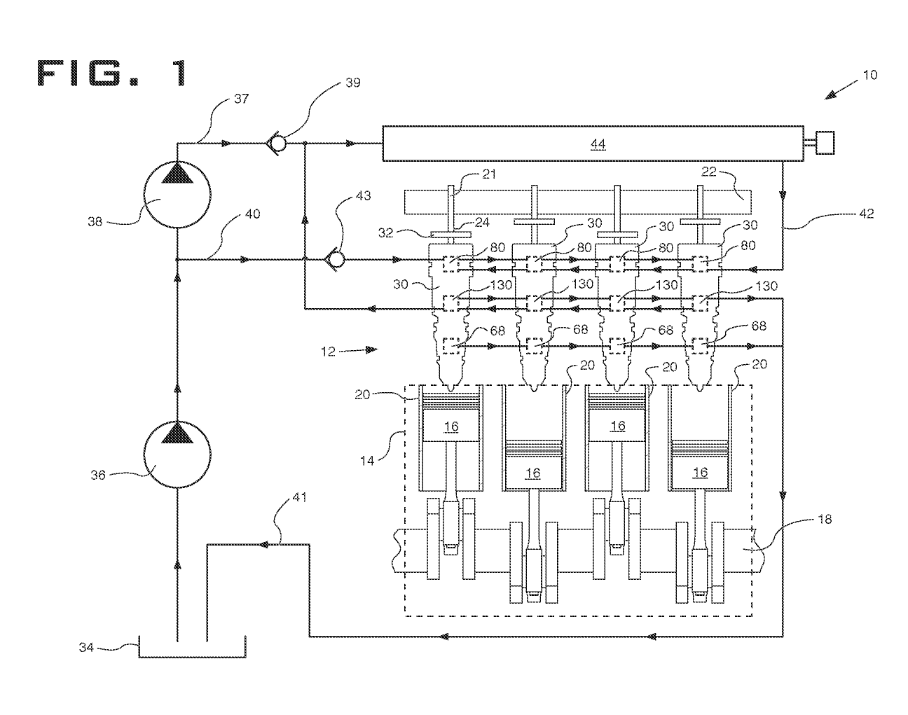

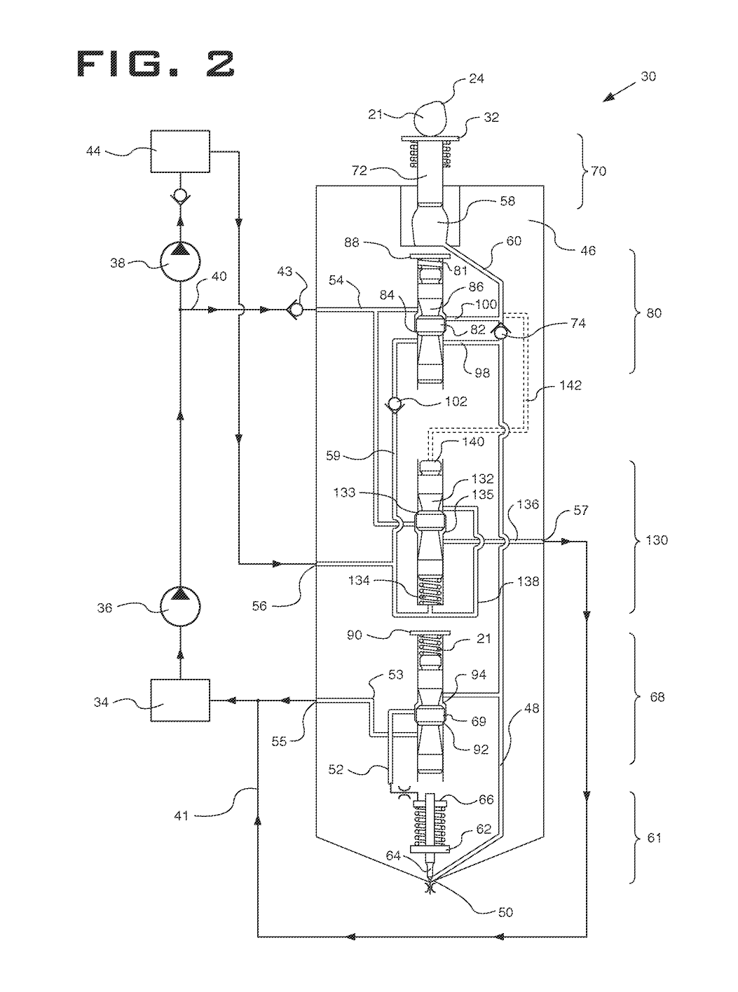

Referring to FIG. 1, there is shown an internal combustion engine 10 according to one embodiment. Internal combustion engine 10 may include a direct injection compression ignition diesel engine, but might comprise a spark ignited engine, or an engine with a different injection strategy, in other embodiments. Internal combustion engine 10 may include an engine housing 14 which includes a plurality of cylinders 20 disposed therein. A plurality of pistons 16 are associated one with each of cylinders 20, and are coupled with a crankshaft 18, in a conventional manner. A plurality of fuel injectors 30 are associated with each of cylinders 20, and each extend partially into a corresponding one of cylinders 20. In one embodiment, as shown in FIG. 2, each of fuel injectors 30 may include an injector body 46 defining at least one nozzle outlet 50 located within the corresponding cylinder 20. Internal combustion engine 10 may further include a fuel system 12 having a medium pressure common rail 44 which is fluidly connected with each one of fuel injectors 30 via a medium pressure fuel supply conduit 42. Fuel system 12 may further include a fuel source 34, a low pressure fuel pump 36 and a high pressure fuel pump 38. High pressure pump 38 pressurizes fuel and delivers it to medium pressure common rail 44 via fuel supply conduit 37. Fuel supply conduit 37 may further include a check valve 39 disposed between high pressure pump 38 and medium pressure common rail 44. A low pressure fuel supply conduit 40 may connect low pressure fuel pump 36 to each one of fuel injectors 30. Low pressure fuel supply conduit 40 may contain at least one check valve 43 disposed between low pressure fuel pump 36 and fuel injectors 30. A low pressure fuel return conduit 41 may return low pressure fuel from each fuel injector 30 back to fuel source 34.

Internal combustion engine 10 may further include a camshaft 22 rotatable via operating internal combustion engine 10, and having a plurality of cams 21 each having at least one cam lobe 24 positioned thereon. Each of cam lobes 24 may rotate in contact with a tappet 32 of each one of fuel injectors 30, the significance of which is further described herein. Each of fuel injectors 30 may further include an injection pressure control mechanism 80 positioned therein which enables selection of a fuel injection pressure corresponding to a fuel pressure from medium pressure common rail 44, or an intensified pressure from a pressure intensifier actuated via the corresponding tappet 32, and further described herein. Each fuel injector 30 may further include an outlet check (not shown in FIG. 1) and a check control mechanism 68 including a needle control valve 69 for operating the corresponding outlet check. Each fuel injector 30 may further include a pressure recovery control mechanism 130 positioned therein that enables the fuel injector 30 to be operated in a pressure recovery mode.

Referring now to FIG. 2, there is shown a portion of fuel system 12 including one of fuel injectors 30 illustrated in more detail. As mentioned above, each fuel injector 30 may include an injector body 46. Injector body 46 may define a nozzle supply passage 48, and nozzle outlet 50, which connects with nozzle supply passage 48. Injector body 46 may further define a control passage 52, a low pressure inlet 53 and a low pressure space 54. As will be described in further detail herein, low pressure space 54 connects with or is a part of a low pressure fuel supply conduit 40. Low pressure fuel supply conduit 40 may further include at least one check valve 43 that permits one way fluid communication from low pressure pump 36. Injector body 46 may further define at least one medium pressure inlet 56, connecting with medium pressure common rail 44, and also selectively connecting with nozzle supply passage 48 via medium pressure supply passages 59 and 98. Injector body 46 may further define a plunger cavity 58 and a pressure intensification passage 60 connecting plunger cavity 58 with nozzle supply passage 48 within injector body 46. Fuel injector 30 may further include a nozzle assembly 61 comprising a direct control needle check 62 positioned therein and movable between a closed position blocking nozzle outlet 50 from nozzle supply passage 48, and an open position. Direct control needle check 62 may further include an opening hydraulic surface 64 exposed to a fluid pressure of nozzle supply passage 48, and a closing hydraulic surface 66 exposed to a fluid pressure of control passage 52.

Fuel injector 30 may further include a check control mechanism 68 including a needle control valve 69 movable between a first injection control position at which control passage 52 is blocked from a drain conduit 53 and a second injection control position at which control passage 52 is open to drain conduit 53. A low pressure outlet or drain 55 is shown connecting between needle control valve 69 and low pressure fuel return conduit 41/drain conduit 53.

Fuel injector 30 may further include a mechanically actuated pressure intensifier 70 positioned partially within injector body 46. Mechanically actuated pressure intensifier 70 includes tappet 32 and also includes a plunger 72. Plunger 72 is configured to move between a first plunger position and an advanced plunger position within plunger cavity 58, in response to rotation of cam lobe 24, which is rotatably coupled with cam 21. Fuel injector 30 may also include a first one way valve 74 positioned fluidly between pressure intensification passage 60 and nozzle supply passage 48 and permitting fluid flow from plunger cavity 58 to nozzle supply passage 48. A one way valve 102 may be positioned fluidly between medium pressure inlet 56 and a bidirectional passage 100, and permits fluid flow from medium pressure inlet 56 to bidirectional passage 100. Bidirectional passage 100 can fluidly connect pressure intensification passage 60, and hence plunger cavity 58, with either of medium pressure inlet 56 or low pressure space 54, in a manner and for reasons further described herein.

Fuel injector 30 may further include an injection pressure control mechanism 80 having a first pressure control configuration and a second pressure control configuration. Injection pressure control mechanism 80 blocks plunger cavity 58 from medium pressure inlet 56 and fluidly connects plunger cavity 58 with low pressure space 54 by way of bidirectional passage 100 in the first pressure control configuration. Injection pressure control mechanism 80 fluidly connects plunger cavity 58 with medium pressure inlet 56 by way of bidirectional passage 100, and blocks plunger cavity 58 from low pressure space 54 in the second pressure control configuration. In one embodiment, injection pressure control mechanism 80 may include a poppet valve 82 movable within fuel injector 30. Injector body 46 may define a first seat 84 and a second seat 86. The first pressure control configuration may include a first poppet valve position at which poppet valve 82 contacts first seat 84, and the second pressure control configuration may include a second poppet valve position at which poppet valve 82 contacts second seat 86. Injection pressure control mechanism 80 may further include a first electrical actuator 88 coupled with poppet valve 82 and configured to move poppet valve 82 between the first poppet valve position and the second poppet valve position, alternately contacting first seat 84 or second seat 86.

In the embodiment shown, a single poppet valve 82 is depicted as part of injection pressure control mechanism 80. Poppet valve 82 may be biased toward its first position with a biasing spring 81. Poppet valve 82 may be coupled with a first electrical actuator 88 to facilitate movement of the poppet valve 82 from its first position to its second position. A medium pressure supply passage 98 is shown connecting medium pressure inlet 56 with nozzle supply passage 48, however, an alternative strategy might be used such as connecting nozzle supply passage 48 with medium pressure inlet 56 through another portion of injector body 46. It should be appreciated that other embodiments are contemplated where, for example, a plurality of valves are used in place of a single poppet valve. In still other embodiments, one or more slide-type valves such as spool valves might be used. It should thus be appreciated that a single poppet valve movable between a first seat and a second seat is but one illustrative embodiment, and the present disclosure is not thereby limited.

As mentioned above, fuel injector 30 may also include needle control valve 69 therein. Needle control valve 69 may be biased toward its first position with a biasing spring 71. A second electrical actuator 90 may be coupled with needle control valve 69 and configured to move needle control valve 69 between the first and second injection control positions. Injector body 46 may further define a third seat 92 and a fourth seat 94. As shown in FIG. 2, needle control valve 69 may be a poppet valve movable within fuel injector 30, and contacting third seat 92 at the first injection control position and contacting fourth seat 94 at the second injection control position.

Fuel injector 30 may further include a pressure recovery control mechanism 130. The pressure recovery control mechanism may include a pressure recovery valve 132 movable between a first valve position and a second valve position. In the first position, the pressure recovery valve 132 is biased upward by a biasing spring 134 to a fifth seat 133. In this first position, pressure recovery valve allows fluid communication between the low pressure space 54 and fuel return conduit via drain conduit 136 and drain 57. Those skilled in the art will recognize that alternate embodiments may combine drain 55 and drain 57 into a single drain. Pressure recovery valve 132 includes a hydraulic surface 140 that is exposed to pressurized fluid from plunger cavity 58 via a pressure recovery actuating conduit 142. When hydraulic opening surface received sufficient opening pressure to cause pressure recovery valve 132 to overcome the upward force of biasing spring 134, pressure recovery valve moves to its second position wherein it engages a sixth seat 135. In the second position, pressure recovery valve 132 allows fluid communication between the low pressure space 54, and medium pressure common rail 44 via a pressure recovery conduit 138 formed in injector body 46.

### INDUSTRIAL APPLICABILITY

The foregoing description of an example fuel injector 30 described in connection with FIG. 2 should be understood to refer similarly to each of fuel injectors 30 used in internal combustion engine 10. Likewise, the following description of example operation of fuel injector 30 should be understood to refer similarly to each of fuel injectors 30, as well as the overall operation of fuel system 12. With continued reference to FIG. 2, fuel injector 30 is shown as it might appear just prior to commencement of fuel injection during an engine cycle. Cam lobe 24 is rotating in contact with tappet 32 and causing plunger 72 to move between a refracted position and an advanced position. In the particular configuration shown, plunger 72 is illustrated approximately as it might appear at the retracted position having just drawn fuel at low pressure into plunger cavity 58 via low pressure fuel supply conduit 40. Fuel is also supplied at the medium pressure from medium pressure common rail 44 to medium pressure inlet 56 and to nozzle supply passage 48 by way of medium pressure supply passage 98.

Poppet valve 82 is shown in the first pressure control position at which poppet valve 82 contacts first seat 84. As described herein, with poppet valve 82 at the first pressure control position, plunger cavity 58 is connected with low pressure space 54 by way of pressure intensification passage 60, and bidirectional passage 100. Fuel at medium pressure in nozzle supply passage 48 urges one way valve 74 toward a closed position at which nozzle supply passage 48 is blocked from pressure intensification passage 60. One way valve 102 permits fuel at the medium pressure to flow from medium pressure inlet 56 to nozzle supply passage 48, at least until such time as fuel pressure in nozzle supply passage 48 becomes equal to the medium pressure.

In FIG. 2, poppet valve 69 is shown in its first injection control position contacting third seat 92. As a result, control passage 52 is blocked from drain 55, and fuel at the medium pressure may exert a closing hydraulic force on closing hydraulic surface 66. In one embodiment, needle check 62 may be hydraulically balanced by forces acting on closing hydraulic surface 66 and opening hydraulic surface 64. A biasing spring 67 may maintain needle check 62 in a closed position blocking nozzle outlet 50 from nozzle supply passage 48. In other embodiments, needle check 62 might be held closed at least in part by a relatively greater hydraulic force on closing hydraulic surface 66 than the force acting on opening hydraulic surface 64, such as by using different sized closing versus opening hydraulic surfaces.

When it is desirable to inject fuel into an associated engine cylinder 20 at a medium pressure, second electrical actuator 90 may be energized to move poppet valve 69 away from third seat 92 and towards fourth seat 94. Upon poppet valve 69 contacting fourth seat 94, control passage 52 will be blocked from nozzle supply passage 48, and open to drain 55. As a result, fuel pressure in nozzle supply passage 48 can act on opening hydraulic surface 64 to move needle check 62 towards an open position and thereby allow fuel to be injected via nozzle outlet 50. To end fuel injection, second electrical actuator 90 may be de-energized, allowing poppet valve 69 to move back towards its first injection control position contacting third seat 92. The aforementioned fuel injection process may take place with poppet valve 82 maintained at its first pressure control position contacting first seat 84. It should be appreciated that injection of fuel at the medium pressure may take place irrespective of cam angle, and thus independently of a position or state of pressure intensifier 70. Thus, injection at the medium pressure may take place while plunger 72 is advancing, retracting or stationary. One way valve 74 may block plunger cavity 58 from nozzle supply passage 48 during injecting fuel at the medium pressure, as well as any other time where fuel pressure is greater in nozzle supply passage 48 than in pressure intensification passage 60 and plunger cavity 58.

When it is desirable to inject fuel at a high pressure, first electrical actuator 88 may be energized to move poppet valve 82 to its second pressure control position, fluidly connecting plunger cavity 58 with medium pressure common rail 44 by way of bidirectional passage 100, and blocking plunger cavity 58 from low pressure space 54. Moving poppet valve 82 to the second pressure control position may, but need not, take place just prior to or while plunger 72 is retracting. When poppet valve 82 is moved to its second pressure control position, fuel at the medium pressure may flow by way of one way valve 102, bidirectional passage 100 and pressure intensification passage 60 into plunger cavity 58. It will be recalled that plunger 72 is displacing fuel at low pressure to and from low pressure space 54 in response to rotation of cam lobe 24 so long as poppet valve 82 is in its first pressure control position. Fluidly connecting plunger cavity 58 with medium pressure common rail 44, however, will increase a pressure of fuel in plunger cavity 58 from the low pressure to the medium pressure. Increasing the pressure of fuel from the low pressure may take place while plunger 72 is stationary or retracting. Rotation of cam lobe 24 may be causing plunger 72 to move in a retracting direction, or causing no movement of plunger 72 during increasing the pressure in plunger cavity 58 from the low pressure to the medium pressure, depending upon the profile of cam lobe 24. One way valve 74 may block plunger cavity 58 from nozzle supply passage 48 during increasing a pressure of fuel in plunger cavity 58 from the low pressure to the medium pressure.

In response to further rotation of cam lobe 24 tappet 32 and plunger 72 may move in an advancing direction, and a pressure of fuel in plunger cavity 58 may be increased from the medium pressure to a high pressure. In other words, cam lobe 24 will tend to drive plunger 72 downwardly in the FIG. 2 illustration, increasing fuel pressure in plunger cavity 58 above rail pressure since plunger cavity 58 is blocked from low pressure space 54 and one way valve 102 will tend to move toward a closed position when the pressure from bidirectional passage 100 rises above rail pressure. When it is desirable to inject fuel into the associated engine cylinder 20 at the high pressure, second electrical actuator 90 may be energized to move poppet valve 69 from the first injection control position contacting third seat 92 to the second injection control position contacting fourth seat 94, in a manner similar to injecting fuel at the medium pressure. Since fuel pressure in pressure intensification passage 60 will tend to rise above the rail pressure resident in nozzle supply passage 48, nozzle outlet 50 will become fluidly connected with plunger cavity 58 by moving one way valve 74 to an open position. De-energizing second electrical actuator 90 will allow fuel injection at the high pressure to end. It may be noted that a fluid connection exists between control passage 52 and nozzle supply passage 48 when poppet valve 69 contacts third seat 92. In a practical implementation strategy, poppet valve 69 may be hydraulically balanced. In other embodiments, the plumbing strategy and/or relative sizes of orifices influencing moving poppet valve 69 between its first and second positions, or the sizing of hydraulic surfaces on poppet valve 69, might be varied to make poppet valve 69 hydraulically biased toward its first position or second position, or to provide a damping effect to motion of poppet valve 69. Such modification may be made according to known techniques.

Following injecting fuel at the high pressure, fuel system 12 may be operated in a pressure recovery mode. Operating fuel system 12 in a pressure recovery mode may be understood as returning high pressure fuel back to the medium pressure common rail 44 as opposed to allowing it to be drained back to the fuel source 34. As stated above, injection of fuel at high pressure may be ended when first electrical actuator 88 and second electrical actuator 90 are de-energized and poppet valves 69 and 82 are returned to their respective first positions on valve seats 92 and 84. When this happens, high pressure fuel may still remain in pressure intensification passage 60. Taking the path of least resistance, this high pressure fuel may enter the pressure recovery actuating conduit 142, and apply a force to hydraulic surface 140 of pressure recovery valve 132. The pressure exerted on hydraulic surface 140 causes pressure recovery valve 132 to overcome the force of biasing spring 134. Pressure recovery valve 132 is thus moved to its second position, wherein it engages the sixth seat 135. When pressure recovery valve 132 is in its second position, fluid communication between low pressure space 54 and pressure recovery conduit 138 is established. Thus, so long as poppet valve 82 is in its first position, the high pressure of the fluid in the pressure intensification passage 60 may flow across poppet valve 82, through low pressure space 54, and to pressure recovery conduit 138. Ultimately, this high pressure fuel may be returned to the medium pressure of the medium pressure common rail 44. As pressure within the pressure intensification passage 60 dissipates, there may no longer enough pressure in the pressure recovery actuating conduit 142 to keep pressure recovery valve 132 in its second position. As the force of the biasing spring 134 overcomes the downward pressure of fluid acting on the hydraulic surface 140 of pressure recovery valve 132, the pressure recovery valve 132 is moved back to its first position where it engages the fifth seat 133. When the pressure recovery valve 132 is in its first position, fluid communication is established between low pressure space 54 and drain conduit 136. Fuel within pressure intensification passage 60, whose pressure has now dissipated to the point where it is below rail pressure, is now allowed to drain out of fuel injector 30 via drain conduit 136 and drain 57. This drained fuel is then returned to fuel source 34 via low pressure fuel return conduit 41.

Following injection of fuel at high pressure and operation of fuel system 12 in pressure recovery mode, fuel system 12 may be operated in a low leakage mode. Operating fuel system 12 in a low leakage mode may be understood as returning fuel system 12 to a state at which pressure intensifier 70 is displacing fuel to and from low pressure space 54, and thus returning pressure in plunger cavity 58 to low pressure. To commence operation in the low leakage mode, poppet valve 82 may be returned to the first pressure control position, contacting seat 84. Operation in the low leakage mode may be essentially continuous, except where a high pressure injection is desired, improving over designs where a pressure intensifier continuously pumps at high pressure or a single stage pump attempts to achieve and maintain a high pressure continuously.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

What is claimed is:

1. A method of operating a fuel system for an internal combustion engine comprising the steps of:
increasing a pressure of fuel in a plunger cavity of the fuel injector from a low pressure to the medium pressure by fluidly connecting the plunger cavity with the common rail;
increasing a pressure of fuel in the plunger cavity from the medium pressure to a high pressure by moving a tappet of a pressure intensifier;
injecting fuel at the high pressure into the engine cylinder at least in part by fluidly connecting the nozzle outlet with the plunger cavity; and
operating the fuel system in a pressure recovery mode by returning high pressure fuel within the plunger cavity to the medium pressure of the common rail.

2. The method of claim 1, wherein the tappet of the pressure intensifier is mechanically actuated and moves in response to rotation of a cam.

3. The method of claim 1, wherein the step of operating the fuel system in a pressure recovery mode further comprises:
providing a pressure recovery valve having a closing hydraulic surface in fluid communication with the plunger cavity and wherein said pressure recovery valve is movable between a first position and a second position, wherein in said first position fluid communication between the plunger cavity and a low pressure drain is established and fluid communication between the plunger cavity and the common rail via a pressure recovery conduit is blocked, and wherein in said second position, fluid communication between the plunger cavity and common rail via the pressure recovery conduit is established and fluid communication between the plunger cavity and the low pressure drain is blocked; and
displacing an amount of high pressure fuel from the plunger cavity at least in part such that it acts on the hydraulic surface of the pressure relief valve and moves the pressure relief valve from its first position to its second position.

4. The method of claim 3, wherein the step of injecting fuel further comprises:
energizing a first electrical actuator coupled with a poppet valve and moving the poppet valve from a first position to a second position; and
energizing a second electrical actuator coupled with a needle control valve for a direct control check of the fuel injector, wherein the needle control valve is moved from a first position to a second position, and the direct control check is allowed to move from a first position to a second position thereby facilitating fuel injection.

5. The method of claim 4, wherein the step operating the fuel system in pressure recovery mode further comprises
deenergizing the first electrical actuator and moving the poppet valve from the second position to the first position; and
deenergizing the second electrical actuator coupled with the needle control valve, wherein the needle control valve is moved from the second position to the first position, and the direct control check is moved from the second position to the first position.

6. The method of claim 4 wherein the step of injecting fuel at the high pressure further includes the steps of:
moving the direct control needle check from a closed position blocking the nozzle outlet from a nozzle supply passage to an open position via a pressure of fuel in the nozzle supply passage acting on an opening hydraulic surface of the needle check; and
moving the direct control needle check from the open position to the closed position via a pressure of fuel in a control passage acting on a closing hydraulic surface of the needle check, the pressure of fuel in the control passage being equal to the high pressure.

7. A fuel injector comprising:
an injector body defining a nozzle supply passage, a nozzle outlet connecting with the nozzle supply passage, a control passage, a low pressure space, at least one fuel inlet connecting with the nozzle supply passage, a plunger cavity, a pressure intensification passage connecting the plunger cavity with the nozzle supply passage within the injector body, a pressure recovery conduit, and at least one drain;
a direct control needle check positioned within the injector body and movable between a closed position blocking the nozzle outlet from the nozzle supply passage and an open position, the direct control needle check having an opening hydraulic surface exposed to a fluid pressure in the nozzle supply passage and a closing hydraulic surface exposed to a fluid pressure in the control passage;
a check control valve movable between a first injection control position at which the control passage is blocked from the low pressure space and a second injection control position at which the control passage is open to the low pressure space;
a pressure intensifier positioned partially within the injector body, the pressure intensifier including a tappet and a plunger configured to move between a first plunger position and an advanced plunger position within the plunger cavity;
an injection pressure control mechanism having a first pressure control configuration and a second pressure control configuration, the injection pressure control mechanism blocking the plunger cavity from the at least one fuel inlet and fluidly connecting the plunger cavity with the low pressure space in the first pressure control configuration, and the injection pressure control mechanism fluidly connecting the plunger cavity with the at least one fuel inlet and blocking the plunger cavity from the low pressure space in the second pressure control configuration; and
a pressure recovery mechanism having a first pressure recovery configuration and a second pressure recovery configuration, the pressure recovery mechanism blocking the low pressure space from the pressure recovery conduit and fluidly connecting the low pressure space with the drain conduit in the first pressure recovery configuration, and the pressure recovery mechanism fluidly connecting the low pressure space with the pressure recovery conduit and blocking the low pressure space from the drain conduit in the second pressure recovery configuration.

8. The fuel injector of claim 7 wherein the injection pressure control mechanism includes a poppet valve and the injector body defines a first seat and a second seat, and wherein the first pressure control configuration includes a first poppet valve position at which the poppet valve contacts the first seat and the second pressure control configuration includes a second poppet valve position at which the poppet valve contacts the second seat.

9. The fuel injector of claim 8 further comprising a first electrical actuator coupled with the poppet valve, and a second electrical actuator coupled with the check control valve.

10. The fuel injector of claim 9 wherein the injector body defines a third seat and a fourth seat, the check control valve including a second poppet valve contacting the third seat at the first control valve position and contacting the fourth seat at the second control valve position.

11. The fuel injector of claim 10, wherein the pressure recovery mechanism includes a pressure recovery valve and the injector body defines a fifth seat and a sixth seat, and wherein said pressure recovery valve further includes a closing hydraulic surface in fluid communication with the plunger cavity, and wherein said first pressure recovery configuration includes the pressure recovery mechanism on the fifth seat and the second pressure recovery configuration includes the pressure relief valve in contact with the sixth seat

12. A fuel system for an internal combustion engine comprising:
a plurality of fuel injectors, each of the fuel injectors including an injector body defining a nozzle supply passage, a nozzle outlet connecting with the nozzle supply passage, a low pressure space, and a drain;
a plurality of mechanically actuated pressure intensifiers each including a tappet and being positioned partially within one of the injector bodies;
a common rail fluidly connecting with each of the fuel injectors; and
each of the fuel injectors further having an injection pressure control mechanism which includes an injection pressure control valve movable between a first pressure control position and a second pressure control position;
wherein each of the injection pressure control valves blocks the corresponding pressure intensifier from the common rail and fluidly connects the pressure intensifier with the low pressure space at the first pressure control position, and wherein each of the injection pressure control valves fluidly connects the pressure intensifier with the common rail and blocks the pressure intensifier from the low pressure space at the second pressure control position; and
each of the fuel injectors further having a pressure recovery mechanism, which includes a pressure recovery valve movable between a first pressure recovery position and a second pressure recovery position;
wherein each of the pressure recovery valves blocks the corresponding pressure intensifier from the common rail and fluid connects the pressure intensifier with the drain at the first pressure recovery position, and wherein each of the pressure recovery valves fluidly connects the pressure intensifier with the common rail and blocks the pressure intensifier from the drain at the second pressure recovery position.

13. The fuel system of claim 12 wherein each of the injection pressure control mechanisms includes an electrical actuator, and each of the injection pressure control valves includes a poppet valve coupled with the electrical actuator and being movable between the first pressure control position and the second pressure control position by energizing the electrical actuator, each of the injector bodies further defining a first seat and a second seat, the poppet valve contacting the first seat at the first pressure control position and contacting the second seat at the second pressure control position.

14. The fuel system of claim 13 wherein:
each of the fuel injectors further includes a direct control needle check, a second electrical actuator and a check control valve which includes a second poppet valve coupled with the second electrical actuator and being movable between a first control valve position and a second control valve position by energizing the second electrical actuator; and
each of the injector bodies further defines a third seat, a fourth seat and a control passage, the second poppet valve contacting the third seat and blocking the control passage from the low pressure space at the first control valve position, and the second poppet valve contacting the fourth seat and fluidly connecting the control passage with the low pressure space at the second valve position.

15. The fuel system of claim 14, wherein
each of the pressure recovery mechanisms include a biasing spring biasing the respective pressure recovery valves toward the first pressure recovery position, and wherein each pressure recovery valve further includes a closing hydraulic surface in fluid communication with the pressure intensifier, and wherein pressurized fluid from each pressure intensifier acts on each closing hydraulic surface to move the respective pressure recovery valves from their respective first pressure recovery positions to their respective second pressure recovery positions low pressure space at the second control valve position; and
each of the injector bodies further defines a fifth seat, a sixth seat, a low pressure drain and a pressure recovery conduit, wherein in said first pressure recovery position, the pressure recovery valves are in contact with the fifth seat and fluid communication between the plunger cavity and a low pressure drain is established and fluid communication between the plunger cavity and the common rail via a pressure recovery conduit is blocked, and wherein in said second pressure recovery position, the pressure recovery valves are on the sixth seat and fluid communication between the plunger cavity and common rail via the pressure recovery conduit is established and fluid communication between the plunger cavity and the low pressure drain is blocked.
